(19) United States
(12) Patent Application Publication
(10) Pub. No.: US 2004/0236505 A1
(43) Pub. Date: Nov. 25, 2004

(54) Method and device for ouput of data on an attribute on a digital street map

(76) Inventors: Volker Entenmann, Affalterbach (DE); Hans J. Kueting, Remseck (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/481,427

(22) PCT Filed: May 16, 2002
(86) PCT No.: PCT/EP02/05401

(30) Foreign Application Priority Data
Jun. 23, 2001 (DE) 101 30 414.5

(51) Int. Cl. G01C 21/30

(52) U.S. Cl. 701/208; 701/200; 340/995.14

(57) ABSTRACT

The invention relates to a method for outputting data relating to an attribute with a stipulated position on a digital road map.

In line with the invention, information is stored about a vehicle driver's driving past the position of the attribute, and output of the data is preceded by a check to determine whether information is stored, and available information is evaluated and the result of this evaluation is taken as a basis for outputting the data to the vehicle driver.

### BACKGROUND AND SUMMARY OF THE INVENTION

This application claims the priority of German patent document 101 30 414.5, filed 23 Jun. 2001 (PCT International Application No.: PCT/EP02/05401, filed 16 May 2002), the disclosure of which is expressly incorporated by reference herein.

The invention relates to a method and apparatus for regulating the output of data relating to an attribute with a stipulated position on a digital road map.

European patent document EP 0 331 675 B1 describes a device for a vehicle, with an output circuit for route data, and a memory which has additional, safety-related data. These safety-related data are correlated to the geographical data in the position-finding system and, if required, are output. In addition, it is possible to take account of current driving data, (preferably speed) when outputting the additional data.

German patent document DE 198 31 131 A1 describes a method in which the driver of a vehicle can store data concerning events that occur on a section of road during the journey, in particular, while driving on a section of road for the first time, the driver can manually store data about events which occur. During the next journey on this section of road, the stored data are output as a driving recommendation.

One object of the invention is to provide a method and apparatus of the type described above, such that traffic safety and convenience for the driver are increased.

This and other objects and advantages are achieved by the data outputting method and apparatus according to the invention in which the output of data relating to an attribute on a digital road map is preceded by a check of whether information is available for at least one earlier instance of a vehicle driver's driving past the location of this attribute (hereinafter referred to simply as “information”). If such information is available, it is evaluated and the result of such evaluation is taken as a basis for deciding whether to output the data relating to the attribute in question. That is, for surroundings which are unfamiliar to the driver, outputting attribute data increases traffic safety by allowing the vehicle driver to prepare in advance for a traffic situation with which he needs to deal. On the other hand, suppressing the output of the attribute data on a road on which the vehicle driver drives frequently and which is thus known avoids bothering or needlessly disturbing the vehicle driver. This advantageously takes account of any current need for attribute data by the vehicle driver.

In this case, an “attribute” on a digital road map is understood to include features and/or properties of such features. Features are possibilities (taken into account in a suitable manner on the digital road map) for local forms of real roads, such as road classes or road signs. These features have specific properties depending on the location. By way of example, the feature of a road sign at a particular position can have the property “yield”.

It is particularly advantageous for information to be individually associated with a vehicle driver. This presupposes explicit identification of the vehicle driver, to which end it is possible to use conventional methods. For identification, suitable details are stored, e.g., as part of the information about the drive past the location of the attribute. The information can thus be explicitly associated with a vehicle driver. Upon driving past the location of the attribute again at a later time, only such available information as can be explicitly associated with the current vehicle driver is taken into account during the evaluation.

It is advantageous if every time that the vehicle driver drives past the location of the attribute is counted as information and is stored as the number of previous drives past. This information allows simple and effective assessment of whether the vehicle driver requires data about this attribute. If, for example, the available number of previous drives past is zero, then the attribute is new to the vehicle driver and the data relating to this attribute are output.

It is also possible to prescribe a maximum number of drives past in order to depict the vehicle driver's “learning” of the location and/or properties of the attribute. For example, as long as this maximum number is not reached by the vehicle driver, because he has not yet driven past the position of the attribute an appropriate number of times, data relating to this attribute are output. If the number is exceeded (that is, if the vehicle driver has “committed an attribute to memory”), data relating to this attribute are output no longer. In addition, the vehicle driver can also be provided with further advice. Thus, when the maximum number of drives past the location of the attribute has been reached, it is possible to output advice stating that the data relating to this attribute are being output a final time.

One advantageous embodiment of the invention takes into account the time of the last drive past the location of the attribute when outputting the data. This makes it a simple matter to check whether an attribute covered on the digital road map is already known to the vehicle driver. This is because the vehicle driver may not pay the necessary attention to changes on a road which is known to him, for example, but rather will rely on his previous experience of this road and of the attributes which are known to him. This technique increases traffic safety by pointing out such changes in attributes—such as the existence of a new road sign—to a vehicle driver in good time by outputting the data relating to this attribute.

To the latter end, such attributes on the digital road map are provided with a creation and change time. For example, a comparison of the time of the current drive past with the previous one has been provided with a creation and change time which is between these two drive-past times. In this case, the attribute is new to the vehicle driver and the data are output to him.

Alternatively, it is also possible to use a special digital road map containing only attributes which have been created or changed since a particular time. If this time is later than the time at which the vehicle driver last made a journey, for example, all of the attributes on this special digital road map are new to the vehicle driver. Even if the last time the vehicle drove past the location of the attribute is longer ago than a maximum prescribable time, it is possible to output the attribute data. In this case, this maximum time is calculated as the time difference between the time of the current drive past and the time of the last drive past.

It is very advantageous if filing of information when the vehicle driver drives past the location of the attribute involves detecting and storing the vehicle driver's direction of travel and/or his destination. This allows even more precise selection of the attribute data which are to be output. If, for example, the vehicle driver approaches a crossroads without using a navigation system, then it is not known what turning direction he will take at the crossroads. If, however, at least one last time the vehicle driver drove past the location of the crossroads involved detecting and storing his turning direction at this crossroads, then a preferred turning direction can be selected. It is then possible to output specifically such attribute data as are associated with this preferred turning direction, which avoids bothering the vehicle driver by outputting attribute data which are probably not relevant to him. In addition, by selecting attributes whose location the vehicle driver has a high probability of passing soon, the attributes for which data are output can be selected quickly and advantageously.

In one advantageous embodiment of the invention, a statistical function is used to store the information about the (or each) drive past the location of an attribute on the digital road map. Such a statistical function allows standardized filing, rational storage and rapid access to the information, since it is particularly suitable for the storage format of a digital road map. In this case, such a statistical function is incorporated, by way of example, into the routines for accessing the stock of data for the digital road map.

In this context, it is advantageous to file further characterizing information about the (or each) drive past the position of the attribute; for example, the time, the day of the week, the weather conditions at the time, or particular features of the day and/or journey during a drive past. Such further information allow even more targeted data output by allowing even better classification of a current journey into the total of the journeys already made by the vehicle driver. This technique optimizes assessment of the vehicle driver's need for attribute data and hence the selection of the attributes for which data are output.

One preferred embodiment of the invention uses the statistical function in order to classify the attributes present on a digital road map on the basis of a drive past and to output data relating to these attributes on the basis of this classification. In this context, it is advantageous to perform this classification on a driver-specific basis in order to meet the vehicle driver's need for attribute data individually and to output such data as are particularly suitable for the vehicle driver. To this end, the prescribed statistical function is aligned by a driver-specific statistical data record, (e.g., after the vehicle driver has been identified). Data relating to an attribute are output visually, audibly and/or haptically, for example. In this case, the vehicle driver can influence the output according to his needs and wishes. For example, he can intermittently suppress the output, buffer-store it or retrieve it on request. It is also possible to control assistance systems which actively engage in the driving mode.

An apparatus for outputting data relating to an attribute with a stipulated location on a digital road map comprises a means for outputting the data, a means for storing information about the vehicle driver's driving past the position of the attribute, and a processing unit for evaluating any information filed in the memory means. The processing unit, which can be in the form of a vehicle computer, for example, also outputs the attribute data to the vehicle driver using the means for output on the basis of the result of the evaluation of any information filed in the memory means. The means for storing the information is in the form of a peripheral component of the vehicle computer, for example. Alternatively, the processing unit is provided by additional functions of a unit which is already present in the vehicle (e.g., by a control unit).

The output means is in the form of a display unit of conventional design, such as an LCD (“Liquid Crystal Display”) or imaging in the front windshield (“Head-Up Display”). It is likewise possible to have audible outputs (e.g., an audio system) or haptic outputs (e.g., a “force-feedback” control element, whose use exerts a counter force on the control element). A large number of further options for outputting the data can of course also be implemented. In addition, the data which are output can be processed further and supplied to other systems, particularly assistance systems in the vehicle.

In another refinement of the invention, e.g., when the vehicle uses offboard navigation, part of the apparatus described can also be arranged in a service control center (a central processing unit having a database which can be used wirelessly by subscribers to a corresponding service). In this case, the vehicle would transmit at least information about its position to the control center (e.g., at the request of the control center and/or of the vehicle driver). The control center, which comprises the processing unit and the means for storing the information, would process this received information and would then transmit the attribute data to be output to the vehicle. Alternatively, it is also possible to split the apparatus between the control center and the vehicle in a different way. First, by way of example, just the means for storing the information about the vehicle driver's drive past the position of the attribute can be arranged in the control center, and the processing unit can be arranged in the vehicle.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a schematic block diagram of an embodiment of the apparatus according to the invention, for outputting data relating to an attribute on a digital road map;

FIG. 2 shows an exemplary flowchart for the output of data relating to an attribute on a digital road map.

### DETAILED DESCRIPTION OF THE DRAWINGS

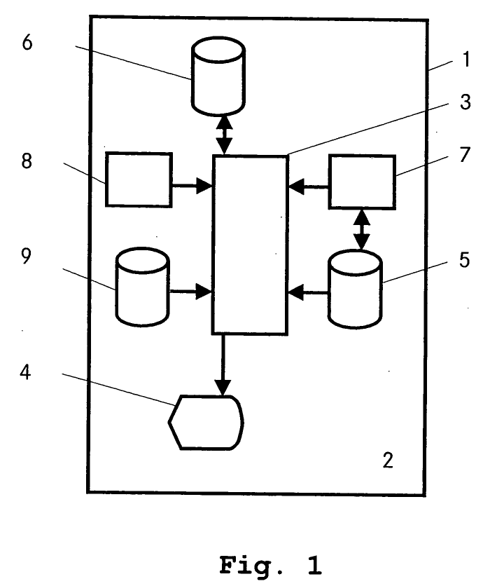

FIG. 1 shows a motor vehicle 1 with an apparatus 2 for outputting data with a processing unit 3. The apparatus 2 comprises a means 4 for outputting the data (subsequently called output means 4 for short) relating to an attribute on a digital road map 5 and a means 6 for storing information about a drive past the position of an attribute (subsequently called memory means 6 for short). In addition, the apparatus 2 comprises a position-finding device 7 which accesses the digital road map 5. The position-finding device 7 is part of a conventional navigation unit, for example.

The apparatus 2 likewise comprises a means for driver identification 8 (subsequently called ID means 8 for short). The ID means 8 is connected to the engine's starting apparatus, for example in the form of a fingerprint sensor (recognition of the vehicle's “fingerprint”). When the vehicle driver initiates the starting process for the engine, he is identified by the ID means 8. Next, a statistical data record provided for the vehicle driver is retrieved from a memory 9 and is prescribed for use by the statistical function for the vehicle driver. Alternatively or in addition, an electronic data storage medium can be provided for the combination of memory 9 and ID means 8, such electronic data storage medium being carried by the vehicle driver—e.g., a driver-specific chip card—and being inserted into an apparatus which is connected to the vehicle. The chip card stores driver-specific values which are evaluated by the processing unit 3 and prompt selection of a statistical data record provided for the vehicle driver.

Alternatively or in addition, the memory 9 can also be provided outside of the vehicle. By way of example, the memory 9 can be provided in a service control center (a central processing unit with a database which can be used wirelessly by subscribers to a corresponding service). The service control center transmits, by way of example, a statistical data record provided for the vehicle driver wirelessly to the vehicle whenever this control center detects that a transmission and reception unit (“radio key”) carried by the vehicle driver is initiating the starting process for the vehicle. Alternatively or in addition, the memory means 6 is also arranged in the service control center.

The position-finding device 7 is used to store information about the vehicle driver's driving past the location of an attribute on the digital road map 5 in the memory means 6 on the basis of destination. To this end, the journey destination, once reached, is determined by the position-finding device 7 when the journey has ended. The destination is then automatically stored by the processing unit 3 together with the information about the drive past the locations of the attributes for the journey just made. Besides the number of drives past the position of the attribute, it is also possible to store further information, such as the time of the drive past, weather conditions or particular features of the journey.

In addition, the processing unit 3 reads out information filed in the memory means 6 relating to one or more earlier drives past the location of an attribute on the digital road map 5, evaluates this information on a driver-specific basis by using the statistical data record provided for the vehicle driver, and outputs the data relating to an attribute on the output means 4 on the basis of the result of this evaluation. The output means 4 is a display, for example. As a further alternative or in addition, an audible output is provided for the output means 4. By way of example, the memory means 6 is of conventional design in the form of part of the customary peripheral components of the processing unit 3.

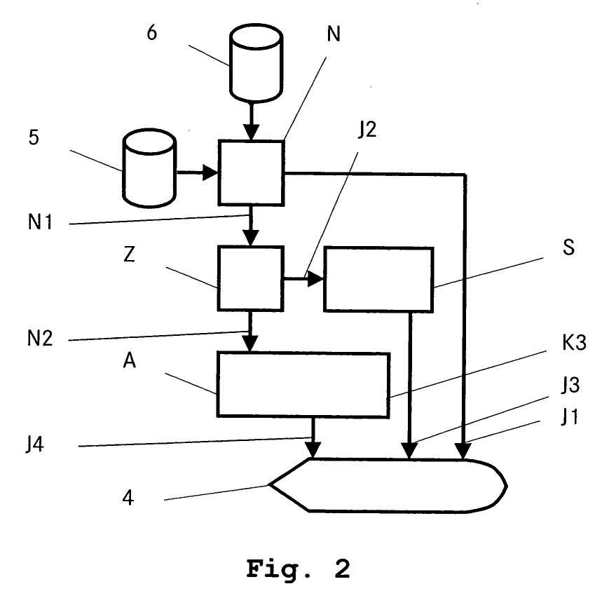

FIG. 2 is a flowchart that illustrates a representative process for the output of data relating to an attribute on a digital road map 5 by an output means 4. For each attribute filed in the digital road map 5, a classification is prompted by using the information, stored in the memory means 6 on the basis of journey destination and driver, about the (or each) drive past the location of the attribute. The statistical data record provided for the vehicle driver uses the information stored in the memory means 6, the time of an attribute change (stored in the digital card) and the time of the current journey in order, for example, to classify each attribute in precisely one of the following three categories on a driver-specific basis: “attributes which are new” (“category 1”), “attributes for which the last drive past is longer ago than a particular length of time and/or for which an upper limit value for drives past has not yet been reached” (“category 2”), and “attributes for which an upper limit value for drives past has been reached” (“category 3”). Attributes in category 1 have the highest output priority, since they are the most important for safely dealing with the driving task. Attributes in category 3 are known to the vehicle driver and therefore have the lowest output priority. The vehicle driver now selects whether data relating to all the attributes need to be output to him (that is, relating to attributes in categories 1, 2 and 3), or whether he wants selective output of data relating to attributes. In the case of selective data output, the vehicle driver can choose whether data relating to attributes in categories I and 2 or just to attributes in category 1 need to be output to him. Data relating to attributes in category 3 are suppressed during the selective output of attribute data. Provision is made for this selection by means of a switch suitable for this purpose or voice control, for example.

If data relating to an attribute on a digital road map 5 now need to be output by an output means 4, then at first, in a processing step N, the statistical data record provided for the vehicle driver is used to check whether this attribute is new to the vehicle driver, that is to say whether it is classified in category 1. If the attribute is new, a signal J1 is sent to the output means 4 to output data relating to this attribute. If the attribute is not new, a signal N1 is sent to a processing step Z, in which it is determined whether the last drive past the location of this attribute is longer ago than a particular length of time and/or whether an upper limit value for drives past has not yet been reached, that is to say whether the attribute is classified in category 2.

If the attribute is classified in category 2, a signal J2 is sent to a processing step S, where a check is made to determine whether the vehicle driver has set selective output of attribute data in categories 1 and 2. In this case, a signal J3 is sent to the output means 4 for the purpose of outputting the attribute data.

If the processing step Z determines that the attribute is not classified in category 2, a signal N2 is sent to a processing step A. If processing step A detects that the vehicle driver has set output of data relating to all attributes, that is to say relating to attributes in categories 1, 2 and 3, then a signal J4 is sent to the output means 4 for the purpose of outputting these attribute data.

The category determined through the use of the statistical data record provided for the vehicle driver (said category having an attribute on the digital map classified in it) changes with the number of drives past the location of this attribute. If, for example, an upper limit value for the number of times the vehicle driver has driven past an attribute classified in category 2 is reached, then this attribute is subsequently classified in category 3, (that is, it is no longer classified in category 2). So that the vehicle driver does not interrupt this as a system malfunction, the vehicle driver can be provided, when data relating to a particular attribute are probably output for the last time, with advice stating that this attribute will be regarded as “known” in future.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (Cancelled)

11. A method for controlling output to a vehicle driver of data relating to an attribute with a stipulated location on a digital road map, said method comprising:
storing information regarding the vehicle driver's previously driving past the location of the attribute;
whenever the vehicle driver drives past the location of the attribute, checking to determine whether information is stored regarding the attribute;
evaluating available information; and
determining whether to output data to the vehicle driver based on a result of the evaluation.

12. The method as claimed in claim 11, further comprising:
storing details regarding which vehicle driver is driving past the location of the attribute; and
evaluating only such available information is associated with the current vehicle driver.

13. The method as claimed in claim 11, wherein the stored information includes a number of times the location of the attribute has been driven past previously.

14. The method as claimed in claim 11, wherein the stored information includes a time at which the location of the attribute was last driven past.

15. The method as claimed in claim 11, wherein a drive past is recorded on the basis of at least one direction and a journey destination which has been ascertained.

16. The method as claimed in claim 11, wherein at least one edge or node on the digital road map has a statistical function provided for it which is used to process information from the memory about the or each drive past.

17. The method as claimed in claim 16, wherein the statistical function covers further characterizing information about the or each drive past; including at least one of a day of the week, weather and particular features of the day or journey.

18. The method as claimed in claim 16, wherein
the statistical function is used to classify the attributes on the basis of the drive past; and
the classification is taken as a basis for outputting the attribute information.

19. The method as claimed in claim 11, wherein at least one of the following is true:
the attribute information is output on a user-specific basis by one of visual, audible and haptic means; and
the attribute information is processed further and supplied to other systems.

20. An apparatus for outputting data relating to an attribute with a stipulated position on a digital road map, comprising:
a memory which files information about a vehicle driver's driving past the location of the attribute;
a processing unit which, prior to output of the data, evaluates any information filed in the memory and uses a result of such evaluation as a basis for determining whether to output attribute information to the vehicle driver; and
an output unit for communicating output data to the driver.
